(19) United States
(12) Patent Application Publication
(10) Pub. No.: US 2009/0077197 A1
(43) Pub. Date: Mar. 19, 2009

(54) METHOD, PRE-FETCH SERVER, AND SYSTEM FOR PRE-FETCHING THIN AND THICK SLICE IMAGE DATA

(76) Inventor: Mario Eichenseer, Pinzberg (DE)

Correspondence Address: SCHIFF HARDIN, LLP;PATENT DEPARTMENT, 6600 SEARS TOWER, CHICAGO, IL, 60606-6473, US

(21) Appl. No.: 12/209,618

(22) Filed: Sep. 12, 2008

(30) Foreign Application Priority Data
Sep. 13, 2007 (DE) 10 2007 043 730.9

(51) Int. Cl. G06F 15/16

(52) U.S. Cl. 709/217

(57) ABSTRACT

In a method and a system to provide medical image data sets stored in a data archive, wherein an image data set contains either thin slice data or thick slice data. A determination is made as to whether a requested image data set contains thin slice data or thick slice data by means of a detection feature associated with the image data set. The image data set is transmitted to a communication system if the image data set contains thick slice data; otherwise the image data set is transmitted to a buffer. The thick slice data are provided at a communication system and the thin slice data are provided to the buffer for a client.

### BACKGROUND OF THE INVENTION

1. Field of the Invention

The present invention concerns systems and methods to archive and provide medical data. In particular, the present invention concerns systems and method to provide and recognize patient-related medical image data for medical diagnosis, such as the Radiology Information System (RIS) and Picture Archiving and Communication System (PACS).

2. Description of the Prior Art

Today large quantities of medical data are generated in medical examinations. Such data are required for immediate treatment of a patient, but also should be stored over the long term in order to be considered in further treatments at later points in time. For this purpose, all patient-related data are stored that are then viewed by a treating physician or medical professional at a later point in time so that he or she can form a detailed overview of the case history of the patient in a quick and uncomplicated manner.

Archiving systems are known that simultaneously provide various types of medical data of a patient, in particular images of the body or a body part of the patient that have been acquired over long time periods with different diagnosis systems and devices. Such archiving systems (such as, for example, the Picture Archiving and Communication System (PACS)) enable data from different medical technology modalities (such as, for example, magnetic resonance tomography systems, computed tomography systems (CT), positron emission tomographs (PET) systems or other radiological devices) to be processed, stored and administered together with additional patient-related data.

A PACS can be integrated into a radiology information system (RIS) that includes the medical modalities, and can monitor and control all patient-related processes. The RIS can additionally have data archives or can access such archives in order to permanently store patient-related data such as acquired images.

One function of the PACS is to store the patient-related data in a data archive when the data will not be needed over longer time periods. The data archives are thereby often permanent but relatively slow storage units such as digital tapes that, although they enable large data sets to be stored, cannot make the stored data available quickly enough.

If additional diagnoses or treatments should be conducted on the patient, for example if the patient becomes ill again, it is often desirable to view the already present data and images of the patient in order to be able to incorporate his case history into the diagnosis or treatment. Stressful, expensive and complicated duplicate examinations can therefore be avoided.

However, since the employed data archives frequently allow only a very slow access to the data, the PACS already loads the required data from the data archive into a buffer storage in advance in the preparation of a treatment. The physician or the medical personnel can then quickly access the data located in the buffer memory and view and prepare the required images and data of the patient without significant delays.

The PACS offers the advantage that, as a widespread standard, it allows an administration and processing of the most varied data sets. However, the system encounters its limits in the case of particularly large image data sets. For example, data from radiological, three-dimensional findings cannot be handled with the PACS since this possibility is not provided PACS that are conventional today and integrated into clinical operation.

However, in cases in which acquisitions ensue in the form known as thin slice images, in which the body or body parts of the patient are acquired in many thin slices in order to acquire a 3-dimensional image of the appertaining body part, these cannot be processed by the PACS without further measures, so as to be provided for processing or diagnosis in its buffer storage.

It is known to cache data sets of thin slice images available in a buffer or application server and to keep these data sets ready in the buffer for diagnosis or additional treatment. If the image data sets of the thin slice images are no longer required over a longer time span, these are typically stored in the same data archive as the other data.

If the data sets of the 3-dimensional thin slice images (also designated in the following as thin slice data) should be considered again at a later point in time for an additional treatment of the patient, they are loaded by the PACS from the data archive but cannot be processed by the PACS.

This is particularly the case when multiple of these thin slice data sets should be simultaneously provided for diagnosis, since then in principle all individual images of all data sets would have to be kept ready in the buffer storage of the PACS.

The thin slice data therefore must be manually loaded into the buffer or application server in order to then be provided therefrom to the user or a client for use.

### SUMMARY OF THE INVENTION

An object of the present invention is to provide a system and a method which overcome the aforementioned disadvantages.

A further object of the invention is to provide a system and a method with which medical archiving systems can also automatically process large data volumes.

The achievement of this object according to a method is described below, and the alternative embodiments and/or advantages likewise apply to the system according to the invention. The corresponding functional features of the method are implemented by corresponding modules, in particular hardware modules (such as a pre-fetch server) of the system.

To achieve the aforementioned object, the method according to the invention stores medical image data sets in a data archive, each image data set representing either thin slice data or thick slice data, wherein a determination of whether a requested image data set includes thin slice data or thick slice data is made by a detection feature associated with the image data set, the image data set is transmitted to a communication system if the image data set includes thick slice data and otherwise (thus in the event that the image data set comprises thin slice data), the image data set is transmitted to a buffer and the thick slice data are provided to a communication system or thin slice data are provided to a buffer for a client.

The modality can be a magnetic resonance tomography apparatus, a computed tomography (CT) apparatus, a positron emission tomography (PET) apparatus or another radiological or non-radiological imaging medical apparatus.

The client can be computers or workstations from which medical personnel can access the image data sets and can view and/or process these. Multiple clients can be provided that are connected with a PACS or are integrated into the PACS system. A client can also be integrated into the modality.

The PACS can likewise include clients, just like the clients of the application server. Both clients can be installed in parallel on PCs. Data are normally exchanged between the between the background servers but are triggered by the clients.

The communication system can be a Picture Archiving and Communication System (PACS). PACS are known to those skilled in the art.

The thick slice data can be data sets of images that have been acquired with the modality represent two-dimensional images of the body or of a body part of a patient or a corresponding slice image. Multiple slices of slice images can be acquired, but these are not designed for a 3-dimensional finding.

The thin slice data can be data sets of 3-dimensional images that sub-divide the body or a body part of the patient into a plurality of slices. The thin slice data are preferably used for 3-dimensional findings.

The buffer or thin slice memory can be an application server and be designed for data communication with the data archive and additional components.

The method can be implemented in a system according to the invention. Such a system has a data archive, a communication system, a buffer and a pre-fetch server, wherein the pre-fetch server is fashioned to implement the method steps.

The system can be a radiology information system (RIS) which is extended by the pre-fetch server according to the invention. The pre-fetch server can be connected with the data archive and import data form this. The determination and transmission of the image data set according to the invention can ensue via the pre-fetch server.

The method for transmission, provision and communication can advantageously use the DICOM standard.

The detection feature can be integrated into a header of at least the thin slice data set. The determination of whether a requested image data set comprises thin slice data or thick slice data additionally comprises searching the DICOM header of the image data set for a predetermined entry. The predetermined entry can be an index or flag in the header that is set if it deals with thin slice data.

Multiple data sets stored in the data archive can be associated with a process, and all image data sets associated with the process can be provided to the client. A process can thereby comprise all data associated with the patient, such that according to the invention all image data sets registered to the patient are sought and provided. However, a process can also include selection of image data sets or additional filters so that, for example, only image data sets of a patient that were generated in a specific time period or that pertain to a specific organ are sought and provided. It is understood that these filters can be adapted to the respective requirements of the treating medical personnel or the respective necessities.

According to an embodiment of the invention, the determination, transmission and provision ensue automatically. An action by the client or the user is no longer necessary, whereby the provision of the images and therefore the further treatment of the patient is significantly simplified.

The embodiments of the method according to the invention that are described in the preceding can also be fashioned as a computer-readable medium that causes a computer induced to implement the method according to the invention that is described above and by program code encoded in the medium being executed by a processor.

Moreover, it is possible that individual components of the method described in the preceding can be executed in a commercial unit such as a pre-fetch server, and the remaining components can be executed in another commercial unit, so to speak as a distributed system.

### BRIEF DESCRIPTION OF THE DRAWINGS

FIG. 1 schematically illustrates a system to provide medical data according to the prior art.

FIG. 2 schematically illustrates a system according to the invention to provide medical data.

### DESCRIPTION OF THE PREFERRED EMBODIMENTS

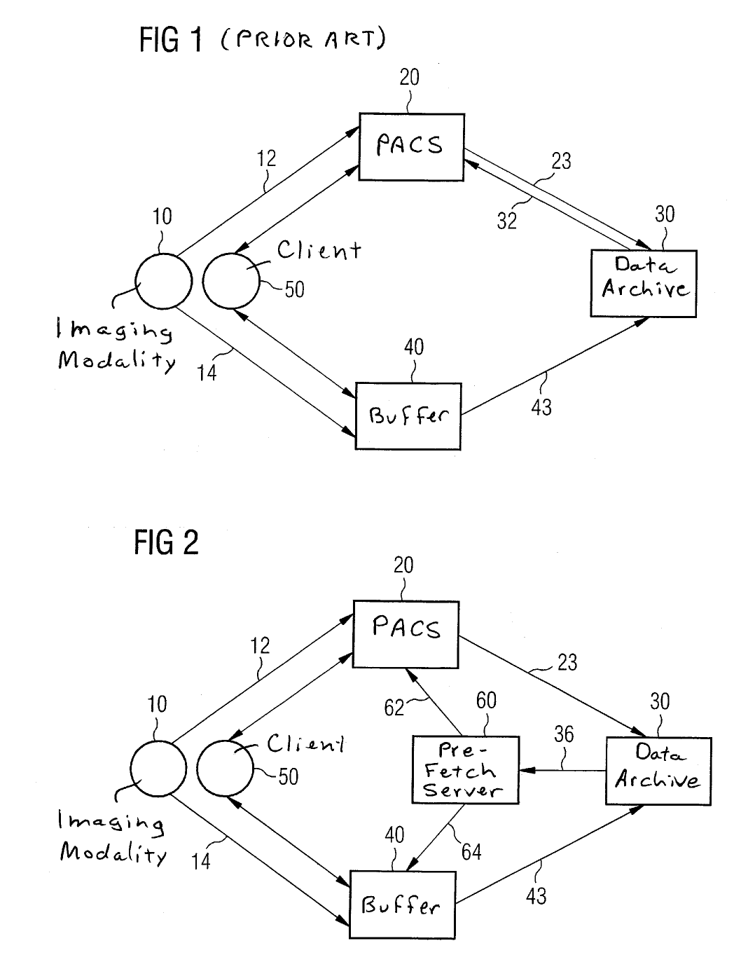

FIG. 1 shows a system to provide medical data according to the prior art. A modality 10 (such as a nuclear magnetic resonance (MR) tomography system, a computed tomography (CT) system, a positron emission tomography (PET) system or another imaging medical apparatus, for example) is connected in a radiology information system (RIS) with a Picture Archiving and Communication System (PACS) 20.

Image data, in particular also image data sets of thick slice images (known as thick slice data) that were acquired with the modality 10, are transmitted via a connection 12 to the PACS 20. The PACS 20 can then administer the image data, i.e. in particular display for diagnostic purposes or for further processing or keep it ready and cache it in a buffer storage for later use. If the image data are no longer required, or are no longer required in the near-term, these are stored in a data archive 30 via a connection 23.

The data archive 30 can be a long-term storage such as a data tape or the like in which large data quantities can be securely stored over long time periods. The data archive 30 typically has a relatively slow access since the data there are stored for longer time periods and not for an instantaneous access.

If the image data stored in the data archive 30 are now required again for a further treatment, these are transmitted via a load connection 32 to the PACS 20 where the image data are then stored in a buffer and provided for the processing, viewing or diagnosis. The transmission of the data to the PACS 20 can thereby already ensue at the beginning or in the preparation of a treatment. Since the relatively slow data archive 30 allows only a limited access speed, the data are advantageously already transmitted to the PACS 20 in the preparation of the treatment. If they are cached there, the corresponding data can be quickly accessed by the modalities 10 connected to the PACS 20 or by a client 50.

The image data to be administered, to be stored and to be provided can be individual images but also image data sets of multiple images. Image data sets are also included that represent and store multiple slices of two-dimensional images. The precision and resolution of the images thereby depends on the pixel size and the thickness of the slices. These images are also designated as thick slice images and stored as thick slice data.

If the slices are relatively thick, the resolution is limited perpendicular to the slices. Such thick slice images form image data sets of a size that can still be handled well with the PACS 20 and can be administered and provided by the PACS 20 in the manner described above.

If a 3-dimensional resolution is required or desirable in order to implement a 3-dimensional finding, for example, the three-dimensional body or, respectively, the body part of the patient to be treated must be sub-divided into multiple thinner slices. The thinner the slices, the more slices that must be acquired and the larger the image data sets of such thin slice images.

However, such large image data sets can no longer be handled by the PACS 20. In particular, the PACS 20 does not have the capability to process 3-dimensional images, thus image data sets of thin slice images. A buffer or application server 40 for processing these thin slice data is known.

The thin slice data are transmitted by the modality 10 via a connection 14 to the buffer 40 instead of to the PACS 20. An application server can be the buffer 40 and can also be designated as a thin slice storage.

The thin slice data stored in the buffer can then be provided at any time to the modality 10 itself or to the client 50 for processing.

If the thin slice data stored in the buffer 40 are not required for a longer period of time, these can be stored in the data archive 30 for long term storage via the connection 43.

If all data belonging to a patient should be provided again for a further treatment of the patient, in the prior art the PACS 20 is instructed by the RIS to provide all patient-related images and image data sets to the user or client 50. The PACS 20 seeks the data belonging to the patient in the data archive 30 and transfers these data via a connection 32 into the buffer storage of the PACS 20. The PACS 20 thus also loads the thin slice data located in the data archive 30, however in principle cannot processes these since (as described above) the PACS 20 is not designed for the processing of 3-dimensional images and for 3-dimensional finding.

It is therefore typical in the prior art to manually register the thin slice data (insofar as this is possible at all) and to transmit these to the buffer 40 in order to keep them ready there for additional processing or diagnosis as described above.

FIG. 2 shows a system according to the invention for automatic provision of medical data. The system according to the invention is based on the system described with reference to FIG. 1 but additionally has a pre-fetch server 60.

The acquisition and long-term storage of the thick slice data and thin slice data in the data archive 30 ensues in the same manner as described above with regard to FIG. 1. According to the invention, at least the thin slice data additionally has an additional detection feature.

The thick slice data and the thin slice data are advantageously administered and stored according to the DICOM standard. The detection feature can then be integrated into the DICOM header of the respective image data set. For example, a fixed index can be provided in the header of the thin slice data in order to identify these as thin slice data. In contrast to this, thick slice data can have a different index, however can have no index at all in this regard and thus be stored in a known manner.

The thin slice data and the thick slice data are transmitted separately, thick slice data to the PACS 20 and thin slice data to the buffer 40 or application server.

It is advantageous for the index of the thin slice data to be set once and to be invariable, such that an image data set labeled once as thin slice data cannot lose this detection feature.

If the RIS now prepares the examination of a patient, according to the invention the pre-fetch server 60 is therefore assigned to load all patient-related image data sets from the data archive 30. The pre-fetch server 60 then searches for all data sets associated with the patient. Each found image data set is then checked for the detection feature, meaning that the corresponding index in the header table is sought if the image data set is stored according to the DICOM standard.

If the detection feature is found in an image data set, the pre-fetch server 60 detects this image data set as thin slice data and transmits it to the buffer 40 via connection 64. If the detection feature is not identified, the image data set is thick slice data or other patient-related data that are then transferred from the pre-fetch server 60 to the PACS 20 via the connection 62. All image data sets associated with the patient are thus made available to the client 50 since the client 50 can access the thick slice data and additional data via the PACS 20, as well as the thin slice data via the buffer 40.

Although the detection feature here is described according to the DICOM standard with regard to the image data set header, it is clear that other detection features with which a pre-fetch server can recognize the data format can also be used with the invention. For example, a specific file ending can also be provided as a detection feature.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method to provide medical image data sets stored in a data archive said image data sets including image data sets comprising thin slice data and other image data sets comprising thick slice data, said method the steps of:
determining whether a requested image data set comprises thin slice data or thick slice data from a detection feature associated with the image data set;
transmitting the requested image data set to a communication system if the requested image data set comprises thick slice data; and
otherwise, transmitting the requested image data set to a buffer of a client, so that the thick slice data are provided at the communication system and the thin slice data are provided to the buffer for a client.

2. A method according to claim 1, comprising:
using a Picture Archiving and Communication System (PACS). as the communication system

3. A method according to claim 1 comprising:
implementing the method in a radiology information system (RIS).

4. A method according to claim 1 comprising:
implementing at least one of said determining, transmitting and/or providing the image data set automatically.

5. A method according to claim 1 comprising:
determining and transmitting the image data set in a pre-fetch server.

6. A method according to claim 1 comprising:
transmitting and providing the image data sets according to the DICOM standard.

7. A method according to claim 1 comprising:
integrating the detection feature into a header of at least the thin slice data set.

8. A method according to claim 7 comprising:
determining whether a requested image data set comprises thin slice data or thick slice data by searching through the DICOM header of the image data set for a predetermined entry representing said detection feature.

9. A method according to claim 1 comprising:
storing multiple image data sets stored in a data archive are associated with a process, and providing all image data sets associated with the process to the client.

10. Pre-fetch server to provide medical image data sets stored in a data archive, said image data sets including image data sets comprises thin slice data and other image data sets comprising thick slice data, wherein the pre-fetch server has access to a data archive and is connected with a communication system and a buffer, said pre-fetch server comprising:
a determination module configured to determine whether a requested image data set comprises thin slice data or thick slice data from a detection feature associated with the image data set; and
a transmission module configured to transmit the requested image data set to the communication system if the image data set comprises thick slice data, and to otherwise to transmit the requested image data set to the buffer for provision to a client.

11. Pre-fetch server according to claim 10, wherein the communication system is a Picture Archiving and Communication System (PACS).

12. Pre-fetch server according to claim 10 wherein the pre-fetch server is integrated into a radiology information system (RIS).

13. Pre-fetch server according to claim 10 wherein the transmission module is configured to transmit and provide the image data sets automatically according to the DICOM standard.

14. Pre-fetch server according to claim 10 wherein the determination module is configured to search through the DICOM header of the image data set for a predetermined entry representing said detection feature.

15. Pre-fetch server according to claim 10 wherein multiple image data sets are stored in the data archive that are associated with a process, and wherein said transmission module is configured used to provide all image data sets associated with the process to the client.

16. A system to provide medical image data sets comprising:
a data archive in which sets are stored that include image data sets comprising thin slice data and other thick slice data;
a communication system;
a buffer; and
a pre-fetch server comprising a determination module configured to determine whether a requested image data set comprises thin slice data or thick slice data from a detection feature associated with the image data set, and a transmission module configured to transmit the requested image data set to the communication system if the image data set comprises thick slice data, and to otherwise to transmit the requested image data set to the buffer for provision to a client.

17. A method according to claim 16 wherein the system is a radiology information system (RIS).

18. a computer-readable medium encoded with programming instructions, said medium being loadable into a pre-fetch server having access to a data archive in which image data sets are stored that include image data sets comprising thin slice date and other image data sets comprising thick slice data, and also having access to a communication system and to a buffer, said programming instructions causing said pre-fetch server to:
determine whether a requested image data set comprises thin slice data or thick slice data from a detection feature associated with the image data set; and
transmit the requested image data set to the communication system if the image data set comprises thick slice data, and to otherwise transmit the requested image data set to the buffer for provisions to a client.
